(19) United States
(12) Patent Application Publication
(10) Pub. No.: US 2008/0210811 A1
(43) Pub. Date: Sep. 4, 2008

(54) Aircraft Engine Unit

(76) Inventors: Lionel Diochon, Toulouse (FR); Jean-Michel Cetout, Toulouse (FR); Olivier Teulou, Buzet sur Tarn (FR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/914,327

(22) PCT Filed: May 23, 2006
(86) PCT No.: PCT/FR06/50469

§ 371 Date: Nov. 13, 2007

(30) Foreign Application Priority Data
May 23, 2005 (FR) 0551332

(51) Int. Cl. B64D 27/00

(52) U.S. Cl. 244/54

(57) ABSTRACT

An engine assembly for an aircraft including a turbojet, a suspension pylon, and a plurality of engine suspensions. The plurality of suspensions include a first forward suspension and a second forward suspension fixed to an engine fan case and located symmetrically about a plane defined by a longitudinal axis of the turbojet and its vertical direction, the first and second suspensions each configured to resist forces applied along a longitudinal direction of the turbojet and along its vertical direction. Furthermore, the plurality of suspensions also include an engine aft suspension configured to resist forces applied along the vertical direction.

### TECHNICAL DOMAIN

This invention relates in general to an engine assembly for an aircraft of the type comprising a turbojet, a suspension pylon, and a plurality of engine suspensions inserted between this suspension pylon and the turbojet.

### STATE OF PRIOR ART

In a known manner, the suspension pylon for such an engine assembly is designed to form the connection interface between a turbojet type of engine and an aircraft wing on which this assembly is fitted. It transmits forces generated by its associated engine to the structure of this aircraft, and it also enables routing of fuel and electrical, hydraulic and air systems between the engine and the aircraft.

In order to transmit forces, the pylon comprises a rigid structure for example of the “box” type, in other words formed by the assembly of spars and side panels connected to each other by transverse ribs.

A mounting system is inserted between the engine and the rigid structure of the pylon, this system globally comprising a plurality of engine suspensions, usually distributed in forward and aft suspensions fixed to the engine fan case or the engine central case.

Furthermore, the mounting system comprises a device for resisting thrusts generated by the engine. In prior art, this device may for example be in the form of two lateral connecting rods connected firstly to an aft part of the engine fan case, and secondly to a suspension fixed onto the rigid structure of the pylon, for example an aft suspension.

For information, note that the suspension pylon is associated with a second mounting system inserted between this pylon and the aircraft wing, this second system usually comprising two or three suspensions.

Finally, the pylon is provided with a secondary structure for segregating and holding systems in place, while supporting aerodynamic fairings.

In a manner known to those skilled in the art, and despite the presence of the thrust resistance device, these thrusts generated by the engine usually generate variable amount of longitudinal bending of the engine, namely bending resulting from a torque applied along a transverse direction of the aircraft.

When such longitudinal bending occurs, particularly during cruising phases of the aircraft, the result is high friction between the rotating compressor and turbine blades and the engine central case.

Furthermore, note that the above-mentioned longitudinal bending phenomenon, and therefore the phenomenon due to friction of the rotating blades is very much accentuated by the fact that in current turbojets, the continuously ongoing search to increase the by-pass ratio inevitably leads designers to increase the fan diameter in comparison to the turbojet core diameter.

The main consequence of friction encountered lies in premature wear of the engine, which is naturally bad for the engine life and performances.

In another case in which appropriate operating clearances are chosen such that there is almost never any contact due to longitudinal bending, the efficiency of the engine is severely reduced.

It should also be noted that other engine bending phenomena may occur as a result of gusts, for example applied vertically or horizontally, that could cause friction between the rotating blades of the compressor and turbine and the engine central case.

### OBJECT OF THE INVENTION

Therefore, the purpose of the invention is to propose an assembly for an aircraft at least partially overcoming the disadvantages mentioned above related to embodiments according to prior art and also to present an aircraft with at least one such assembly.

To achieve this, the purpose of the invention is an engine assembly for an aircraft comprising a turbojet, a suspension pylon and a plurality of engine suspensions inserted between the suspension pylon and the turbojet. According to the invention, the plurality of engine suspensions comprises a first engine forward suspension and a second engine forward suspension fixed to the engine fan case and located symmetrically about a plane defined by a longitudinal axis of the turbojet and a vertical direction of the turbojet, the first and second engine forward suspensions each being designed so as to resist forces applied along a longitudinal direction of the turbojet and along the vertical direction of the turbojet. Furthermore, the plurality of suspensions also comprises an engine aft suspension designed to resist forces applied along the vertical direction of the turbojet.

Thus, allowing for first and second engine forward suspensions to be mounted on the fan case makes it possible to place them at a significant distance from each other. This large separation distance has the advantage that it can very much simplify the design of these engine suspensions, due to the fact that the forces that they must resist associated with a moment about a given axis, are naturally smaller than the corresponding forces encountered in conventional solutions according to prior art in which the engine suspensions that were fixed onto the central case could not be as far away from each other.

Also, these two forward suspensions and the suspension pylon may advantageously be located at a distance from the hot part of the turbojet, which implies a significant reduction in thermal effects that may be applied to these elements.

Furthermore, with such an arrangement that no longer requires the presence of a thrust resistance device of the lateral connecting rods type, all forces generated by the turbojet are resisted essentially on the fan case by means of the first and second engine forward suspensions, because the only link remaining between the pylon and the central case or the exhaust case is formed by the engine aft suspension, the main role of which is to limit vertical oscillations of the aft part of the turbojet.

Thus, this particular arrangement of engine suspensions induces a considerable reduction in the bending encountered at the central case, regardless of whether this bending is due to thrusts generated by the turbojet, or to gusts that may be encountered during the various flight phases of the aircraft.

Consequently, the above-mentioned reduction in bending generates a significant reduction in the friction between rotating compressor and turbine blades and the central case of the engine, and therefore significantly reduces losses of efficiency due to wear of these blades.

Preferably, the engine aft suspension is designed so as to resist only forces applied along the vertical direction of the turbojet, and the plurality of engine suspensions also comprises a third engine forward suspension fixed to the fan case so that the above-mentioned plane defined by the longitudinal axis of the turbojet and its vertical direction passes through it, the third engine forward suspension being designed so as to resist only forces applied along the transverse direction of the turbojet.

Thus, the only engine suspension that is not mounted on the engine fan case is the engine aft suspension, designed so as to resist only the forces applied along the vertical direction of the turbojet. This means that if the latter is effectively located in the annular fan flow duct, its function consisting solely of resisting vertical forces requires a relatively small dimension, such that fan flow disturbances caused by this aft suspension are only very minimal. Thus, this enables a significant gain in terms of global engine performances.

Furthermore, in this configuration in which the aft suspension resisting only vertical forces is the only engine suspension located in the annular fan flow duct, then it will be possible that the first, second and third engine suspensions are fixed onto a peripheral annular part of the fan case, so that they can occupy positions in which they are advantageously well separated from each other.

Preferably, a plane defined by the longitudinal axis of the turbojet and a transverse direction of this turbojet passes through the first and second engine forward suspensions. Thus, since forces are resisted at the turbojet shaft, longitudinal bending of the turbojet shaft is advantageously considerably reduced.

Finally, note that one alternative consists of arranging that the plurality of suspensions does not include the third above-mentioned forward suspension, but that the engine aft suspension is designed to also resist forces applied along a transverse direction of the turbojet, always with the aim of obtaining a plurality of engine suspensions forming a statically determinate mounting system without any thrust resistance device consisting of lateral resisting connecting rods.

Another purpose of the invention is an aircraft comprising at least one engine assembly like that described above.

Other advantages and characteristics of the invention will become clear after reading the detailed non-limitative description given below.

### BRIEF DESCRIPTION OF THE DRAWINGS

This description will be made with reference to the appended figures wherein:

FIG. 1 shows a side view of an engine assembly for an aircraft, according to a first preferred embodiment of this invention.

FIG. 2 shows a diagrammatic perspective view of the turbojet in the assembly shown in FIG. 1, the suspension pylon having been removed to show the engine suspensions more clearly;

FIG. 3 shows a view similar to that shown in FIG. 2, in which the assembly is in the form of a second preferred embodiment of this invention; and

FIG. 4 shows a perspective view of the suspension pylon of the assembly shown in FIG. 1.

### DETAILED DESCRIPTION OF PREFERRED EMBODIMENTS

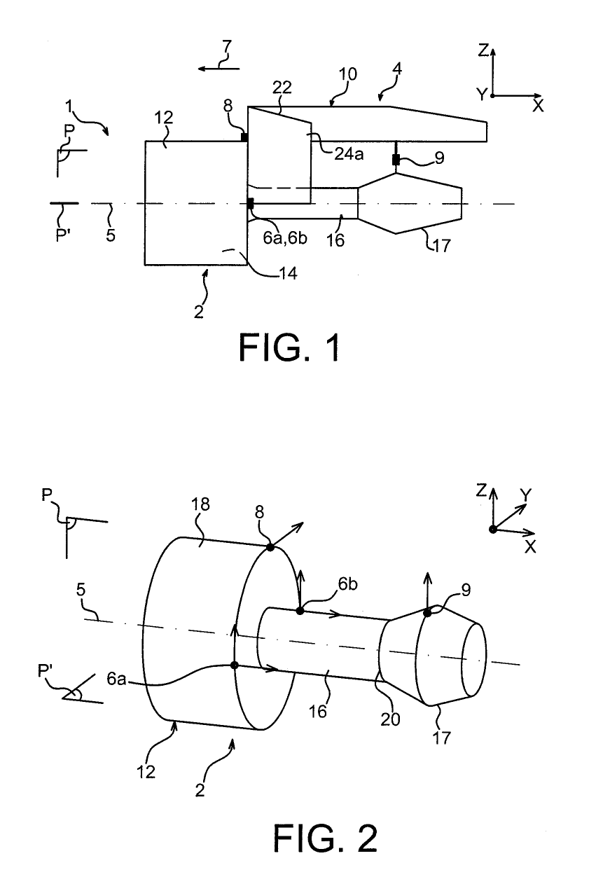

With reference to FIG. 1, the figure shows an aircraft engine assembly 1 according to a first preferred embodiment of this invention, this assembly 1 being designed to be fixed under a wing of an aircraft (not shown).

Globally, the engine assembly 1 comprises a turbojet 2, a suspension pylon 4 and a plurality of engine suspensions 6a, 6b, 8, 9 fixing the turbojet 2 under this pylon 4 (the suspension 6b being concealed by the suspension 6a in this FIG. 1). For guidance, note that the assembly 1 is designed to be surrounded by a pod (not shown) and that the suspension pylon 4 comprises another series of suspensions (not shown) to suspend this assembly 1 under the aircraft wing.

Throughout the following description, by convention X is the direction parallel to the longitudinal axis 5 of the turbojet 2, Y is the direction transverse to this turbojet 2, and Z is the vertical direction or the height, these three directions X, Y and Z being orthogonal to each other.

Furthermore, the terms <<forward>> and <<aft>> should be considered with respect to a direction of motion of the aircraft that occurs as a result of the thrust applied by the turbojet 2, this direction being shown diagrammatically by the arrow 7.

In FIG. 1, it can be seen that only the rigid structure 10 of the suspension pylon 4 is shown. The other constituents not shown of this pylon 4, such as the secondary structure segregating and holding the systems while supporting aerodynamic fairings, are conventional elements identical to or similar to those used in prior art, and known to those skilled in the art. Consequently, no detailed description of them will be made.

Furthermore, the turbojet 2 is provided with a large fan case 12 at the forward end delimiting an annular fan duct 14, and is provided with a smaller central case 16 near the aft end enclosing the core of this turbojet. Finally, the central case 16 is prolonged in the aft direction by an exhaust case 17 that is larger than the case 16. Obviously, the cases 12, 16 and 17 are rigidly fixed to each other. As can be seen from above, it is preferably a turbojet with a high by-pass ratio.

As can be seen in FIG. 1, one of the specific features of the invention lies in the fact that a first engine forward suspension 6a and a second engine forward suspension 6b are both designed to be fixed on the fan case 12, symmetrically about a plane P defined by the axis 5 and the Z direction.

Now with reference to FIG. 2, it can be seen that the first suspension 6a and the second suspension 6b shown diagrammatically are arranged symmetrically about this plane P and are preferably both arranged on a peripheral annular part of the fan case 12, and more specifically near the aft end of this part.

It would then be possible for the first and second engine forward suspensions 6a, 6b to be diametrically opposite to each other on the annular peripheral part of the fan case 12 with a cylindrical outside surface 18, such that a second plane P′ defined by the longitudinal axis 5 and the Y direction passes through each of these suspensions 6a, 6b.

As shown diagrammatically by the arrows in FIG. 2, each of the first and second engine forward suspensions 6a, 6b is designed so that it can resist forces generated by the turbojet 2 along the X direction and along the Z direction, but not forces applied along the Y direction.

In this way, the two suspensions 6a, 6b at a long distance from each other jointly resist the moment applied about the X direction, and the moment applied about the Z direction.

Still with reference to FIG. 2, a third engine forward suspension 8 shown diagrammatically can be seen, also fixed on the annular peripheral part of the fan case 12, also preferably near the aft end of this part.

The suspensions 6a, 6b, 8 are fixed onto the peripheral annular part of the case 12 by structural parts (not shown) of the engine, that are effectively preferably arranged on the aft part of the annular peripheral part. Nevertheless, it would also be possible to have engines in which the structural parts are located further forwards on the peripheral annular part, such that the suspensions 6a, 6b, 8 are also fixed further forwards on the engine, still on the annular peripheral part of the fan case 12.

The third suspension 8 is located on the highest part of the fan case 12, and therefore on the highest part of the peripheral annular part, and consequently the first plane P mentioned above fictitiously passes through it. Furthermore, a YZ plane (not shown) preferably passes through the three suspensions 6a, 6b and 8.

As shown diagrammatically by the arrows in FIG. 2, the third engine suspension 8 is designed so that it can only resist forces generated by the turbojet 2 along the Y direction, but not forces applied along the X and Z directions.

Still with reference to FIG. 2, it can be seen that there is an engine aft suspension 9 shown diagrammatically and fixed between the rigid structure 10 (not shown in this figure) and the exhaust case 17, preferably at the portion of this case 17 with the largest diameter. For guidance, it is noted that the first plane P preferably passes fictitiously through this aft suspension 9.

As shown diagrammatically by the arrows in FIG. 2, the engine aft suspension 9 is designed so that it can only resist forces generated by the turbojet 2 along the Z direction, and therefore cannot resist forces applied along the X and Y directions.

In this way, this suspension 9, with the two forward suspensions 6a, 6b, resist the moment applied about the Y direction.

Naturally, this aft suspension 9 could be placed differently, namely on the central case 16 of the turbojet 2, preferably on an aft part of it, or at a junction 20 between the central case 16 and the exhaust case 17.

Therefore in all cases, this aft suspension 9 is located in an annular fan flow duct (not referenced) of the turbojet with a high by-pass ratio. Nevertheless, the fact that its function is limited to resistance of vertical forces implies that it is relatively small, such that fan flow disturbances caused by this aft suspension 9 are only minimal. Thus, this can give a significant gain in terms of the global performances of the turbojet.

Note that if the engine suspensions 6a, 6b, 8 and 9 are shown diagrammatically in FIGS. 1 and 2, it should be understood that these suspensions can be made using any method known to those skilled in the art, for example such as a method related to assembly of shackles and fittings.

As mentioned above, one of the main advantages associated with the configuration that has just been described lies in the fact that the specific position of the engine forward suspensions 6a, 6b, 8 on the fan case 12 causes a significant reduction in bending of the central case 16 during the various aircraft flight situations, and therefore causes a significant reduction in wear of the compressor and turbine blades by reduction of the friction in contact with this central case 16. Furthermore, another advantage lies in the possibility that operating clearances can be reduced during manufacturing of the engine, therefore obtaining a better efficiency.

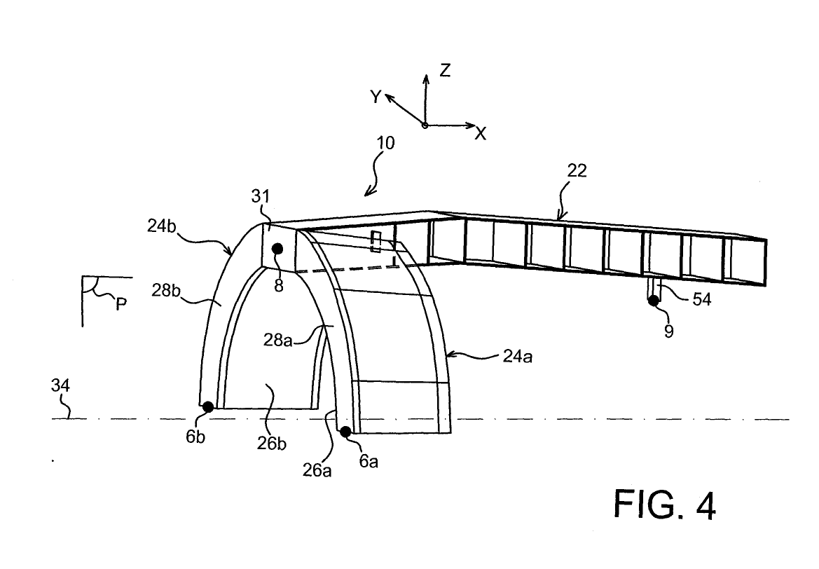

FIG. 4 shows an example embodiment of the suspension pylon, in which only the rigid structure 10 was shown.

Firstly, note that this rigid structure 10 is designed to be symmetric about a first plane P indicated above.

This rigid structure 10 comprises a central torsion box 22 that extends from one end of the structure 10 to the other along the X direction substantially parallel to this direction. For guidance, this box 22 may be formed by the assembly of two lateral spars (not referenced) extending along the X direction in parallel XZ planes, and connected to each other by transverse ribs (not referenced) that are oriented in parallel YZ planes.

Furthermore, the rigid structure 10 supports two lateral boxes 24a, 24b projecting on each side of the box 22 along the Y direction, at a forward end of this box 22.

The two lateral boxes 24a, 24b also support two engine forward suspensions 6a, 6b, and each preferably has a lower skin 26a, 26b jointly delimiting a part of an approximately cylindrical fictitious surface (not shown) with a circular section, and a longitudinal axis 34 parallel to the central box 22 and to the longitudinal axis 5 of the turbojet. In other words, the curvature of each of these two lower skins 26a, 26b is adapted so that the skins can be positioned around and in contact with this fictitious surface over their entire length. Thus in general, the two lateral boxes 24a, 24b form a portion of an approximately cylindrical envelope/cage with a circular section that can be positioned around and at a distance from the central case 16 of the turbojet 2. Obviously, this configuration improves the fan air flow through the assembly 1.

Furthermore, note that the engine forward suspension 6a is fixed to a forward closing frame 28a of the lateral box 24a, while the engine forward suspension 6b is fixed to a forward closing frame 28b of the lateral box 24b, as is diagrammatically shown in FIG. 4 that also shows that the engine forward suspension 8 is mounted on a forward closing frame 31 of the box 22, the frames 28a, 28b, 31 being arranged in the same YZ plane.

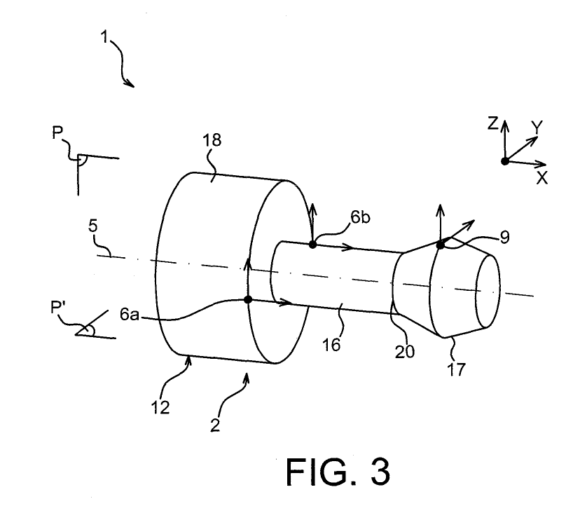

FIG. 3 shows an engine assembly 1 for an aircraft according to a second preferred embodiment of this invention (the suspension pylon not being shown).

This assembly is similar to that described in the context of the first preferred embodiment. Thus, elements marked with the same numeric references correspond to identical or similar elements.

The main difference in this second preferred embodiment consists of eliminating the third engine forward suspension, and arranging that the engine aft suspension 9 not only resists the force applied along the Z direction, but also the force applied along the Y direction.

Thus, this second preferred embodiment, like the first one, provides an alternative to obtain a plurality of engine suspensions forming a statically determinate mounting system.

Obviously, those skilled in the art could make various modifications to the engine assembly 1 for an aircraft that has just been described, solely as a non-limitative example. In this respect, for example, it is worth mentioning that although the engine assembly 1 has been disclosed in a suitable configuration for it to be suspended under the aircraft wing, this assembly 1 could also be designed for a different configuration in which it could be mounted above this wing, or even in the aft part of the aircraft fuselage.

1-10. (canceled)

11. An engine assembly for an aircraft comprising:
a turbojet;
a suspension pylon; and
a plurality of engine suspensions inserted between the suspension pylon and the turbojet, wherein the plurality of engine suspensions comprise a first engine forward suspension and a second engine forward suspension fixed to a fan case of the turbojet and arranged symmetrically about a plane defined by a longitudinal axis of the turbojet and its vertical direction, the first and second engine forward suspensions each configured to resist forces applied along a longitudinal direction of the turbojet and along its vertical direction, and wherein the plurality of suspensions further comprise an engine aft suspension configured to resist forces applied along the vertical direction of the turbojet.

12. An assembly for an aircraft according to claim 11, wherein the engine aft suspension is configured to only resist forces applied along the vertical direction of the turbojet, and wherein the plurality of engine suspensions further comprise a third engine forward suspension fixed to the fan case so that the plane defined by the longitudinal axis of the turbojet and its vertical direction passes through the third engine forward suspension, the third engine forward suspension configured to resist only forces applied along the transverse direction of the turbojet.

13. An assembly for an aircraft according to claim 12, wherein the first, second, and third engine forward suspensions are fixed onto a peripheral annular part of the case.

14. An assembly for an aircraft according to claim 11, wherein a plane defined by the longitudinal axis of the turbojet and its transverse direction passes through the first and second engine forward suspensions.

15. An assembly for an aircraft according to claim 11, wherein the engine aft suspension is configured to also resist forces applied along the transverse direction of the turbojet.

16. An assembly for an aircraft according to claim 11, wherein the engine aft suspension is fixed to a central case of the turbojet.

17. An assembly for an aircraft according to claim 11, wherein the engine aft suspension is fixed to an exhaust case of the turbojet.

18. An assembly for an aircraft according to claim 11, wherein the engine aft suspension is fixed at a junction between a central case of the turbojet and its exhaust case.

19. An assembly for an aircraft according to claim 11, wherein the plurality of engine suspensions form a statically determinate mounting system.

20. An aircraft comprising at least one engine assembly according to claim 11.
